(19) United States
(12) Patent Application Publication
(10) Pub. No.: US 2025/0208023 A1
(43) Pub. Date: Jun. 26, 2025

(54) FLOW CELL AND MEASUREMENT APPARATUS FOR PERFORMING SURFACE-ENHANCED RAMAN SPECTROSPIC MEASUREMENTS

(71) Applicant: Endress+Hauser Optical Analysis, Inc., Ann Arbor, MI (US)

(72) Inventor: Justin Moretto, Apex, NC (US)

(21) Appl. No.: 18/391,902

(22) Filed: Dec. 21, 2023

(51) Int. Cl. G01N 15/1434; G01N 15/10

(52) U.S. Cl. CPC G01N 15/1436; G01N 2015/1006

(57) ABSTRACT

A flow cell for performing surface-enhanced Raman spectroscopic measurements of at least one measurand of a medium and a measurement apparatus comprising the flow cell includes: a cell body; a flow channel extending through the cell body and configured to convey the medium; a SERS-substrate disposed on a surface adjacent the flow channel inside the cell body, the SERS-substrate including a nanostructured layer and a transparent, chemically inert passivation layer covering an outside surface of the SERS-substrate adjacent the flow channel; and a transmission window configured to permit excitation light to be transmitted through the transmission window to the SERS-substrate inside the cell body and to permit measurement light including Raman scattered light emanating from the medium inside the flow channel to be received through the transmission window.

### TECHNICAL FIELD

The present disclosure relates to surface-enhanced Raman spectroscopy and, in particular, to a flow cell and a measurement apparatus for performing surface-enhanced Raman spectroscopic measurements of at least one measurand of a medium.

### BACKGROUND

Conventional Raman spectrometers commonly include a light source transmitting monochromatic excitation light to a sample of a medium and a spectrometric unit determining measured spectra of Raman scattered light emanating from the illuminated sample. The measured spectra are, e.g., provided to an evaluation unit determining a measurand, e.g., a concentration of a target analyte included in the medium, based on the measure spectra, e.g., based on a previously determined model for determining the measurand based on spectral intensities of the measured spectra.

One of the disadvantages of conventional Raman spectroscopy is that the intensity of Raman scattered light emanating from illuminated samples is notoriously low. This limits the measurement range. As an example, measurements of concentrations of a target analyte included in a medium are normally limited to concentrations exceeding a certain minimum, e.g., a minimum concentration value of 50 ppm.

In consequence, conventional Raman spectroscopy is unsuitable for applications in which measurements of considerably lower concentrations are required and/or desirable. These applications, e.g., include applications in the life science industry, in bioprocessing and in the pharmaceutical industry, where concentrations of target analytes may be significantly lower than the minimum concentration required for conventional Raman spectroscopy.

In this respect surface-enhanced Raman spectroscopy (SERS) constitutes a promising alternative. In SERS, an enhancement of Raman scattered light emitted by molecules of target analytes is achieved by exposing the molecules to an evanescent field emanating from a SERS-substrate receiving excitation light.

Due to the short range of the evanescent field, SERS measurements are commonly performed on molecules of a target analyte adsorbed on the SERS-substrate.

As an example, the article titled, “Raman Spectroscopic Detection in Continuous Microflow Using a Chip-Integrated Silver Electrode as an Electrically Regenerable Surface-enhanced Raman Spectroscopy Substrate,” by Eva Maria Höhn, Rajapandiyan Panneerselvam, Anisch Das and Detlev Belder, published Jul. 1, 2019, in the journal Analytical Chemistry, volume 25, discloses an electrochemical approach in which a silver electrode is integrated as SERS-substrate in a microfluidic chip device and SERS measurements are performed on molecules adsorbed on the SERS-substrate. Following the SERS measurements, a regeneration process is performed in which actuation pulses of about 4 V are applied to the SERS-substrate to strip off analytes adsorbed on the SERS-substrate.

Even though this SERS measurement method may be well suited to detect the presence of a target analyte in a medium, it appears to be significantly less suitable or even unsuitable for performing in-line measurements, e.g., in-line concentration measurements of a target analyte included in a medium processed and/or produced in a specific application.

One of the reasons for this is that adsorption of molecules on the SERS-substrate may disrupt the structure and/or destroy the molecules. This may prevent further use of the colloidal medium including the molecules. In addition, adsorption is an exothermic process, which may also prevent further use of the medium in certain applications.

Another problem is that adsorption is a non-linear process exhibiting a time dependent adsorption rate that decreases as the number of molecules adsorbed on the SERS-substrate increases. The resulting time dependent number of adsorbed molecules of a target analyte makes it difficult to accurately determine the concentration of the target analyte dispersed in the medium.

In addition, the regeneration process required between consecutive measurements may be incompatible with other requirements, e.g., a processing procedure to be performed and/or a processing time scale to be kept, prevailing in certain applications. Further disadvantages are that the regeneration process may be destructive, that it may produce unwanted chemical debris, and that it may affect the medium in a manner preventing further use of the medium.

As a result, SERS measurements on adsorbed molecules as well as SERS measurement methods requiring regeneration processes are rather unsuitable for performing in-line measurements, e.g., measurements on a medium processed and/or produced at a measurement site.

In addition, using a silver electrode as SERS-substrate provides the disadvantage that silver is a strongly Raman active metal. As a result, Raman scattered light emanating from the silver substrate constitutes an interference signal that may impair the SERS-measurements and/or reduce the achievable measurement accuracy. A further disadvantage is that the silver electrode may be unsuitable for applications requiring aseptic or sterile conditions and/or incompatible with cleaning in place (CIP) and/or steaming in place (SIP) protocols that may be required in theses application. In addition, the SERS-enhancement achievable with simple geometries, such as the continuous flat extrusion of silver used in the article, is rather weak.

The article titled, “A Flow-Through Microarray Cell for the Online SERS Detection of Antibody-Captured E. Coli Bacteria,” by Maria Knauer, Natalia P. Ivleva, Reinhard Niessner, and Christoph Haisch, published in 2012 in Analytical and Bioanalytical Chemistry, volume 402, pages 2663-2667, discloses an immunoassay microarray system for the SERS analysis of bacteria. The system is designed to perform a SERS measurement method, wherein antibodies are adsorbed on a flow cell substrate in order to bind molecules of a specific analyte. The flow cell is then charged with a sample of a medium and colloidal metal nanoparticles enabling the SERS measurements are added to the medium.

The binding kinetics of the antibodies change the Raman spectra and provide excellent signal isolation and enhancement. A disadvantage is, however, that the system used in the article by Knauer et al. is designed as a single use system that cannot be operated in a continuous manner. Moreover, the choice of antibodies limits the field of use of the system to the detection of the analyte binding to the antibodies.

Another disadvantage is that quantitative measurement results strongly depend on the number of analyte molecules bound to the antibodies. Correspondingly, measurements can vary significantly when the volume of the medium including the analyte is not kept exactly equivalent.

In addition, binding of analyte molecules is undesirable in applications where in-line measurements are required and/or desirable. Just like adsorption, binding may modify and/or impair the medium including the analyte molecules in a manner that may prevent further use of the medium.

A further disadvantage is that the system requires loose nanoparticles to be added to the medium. This normally prevents further use of the medium and thus renders the system unsuitable for in-line measurements.

Accordingly, there remains a need for further contributions in this area of technology.

As an example, there is a need for SERS measurement instrumentation enabling in-line measurements of at least one measurand of a medium conveyed in a flow cell. In this respect, there is, e.g., a need for SERS-measurement instrumentation that enables a further use of the medium and/or that reduces or eliminates adverse effects of the SERS measurements on the medium.

As another example, there is a need for SERS-measurement instrumentation that can be continuously operated without requiring a regeneration process to be performed between consecutive measurements.

As further example, there is a need for SERS-measurement instrumentation enabling measurements of different or multiple measurands, e.g., concentrations of different target analytes, and/or that can be employed in a preferably large variety of different applications, e.g., in applications requiring a high degree of hygiene, cleanliness and/or sterility with respect to any instrumentation contacting the medium.

As a yet further example, there is a need for SERS-measurement instrumentation that is more robust, e.g., robust enough to withstand averse process conditions and/or robust enough to be cleaned and/or sterilized in place.

### SUMMARY

The present disclosure includes a flow cell for performing surface-enhanced Raman spectroscopic measurements of at least one measurand of a medium. The flow cell comprises a cell body, a flow channel extending through the cell body and configured to convey the medium, and a SERS-substrate disposed on a surface adjacent the flow channel inside the cell body. The SERS-substrate includes a nanostructured layer and a transparent, chemically inert passivation layer covering an outside surface of the SERS-substrate adjacent the flow channel. The flow cell further comprises a transmission window configured to permit excitation light to be transmitted through the transmission window to the SERS-substrate inside the cell body and to permit measurement light including Raman scattered light emanating from the medium inside the flow channel to be received through the transmission window.

The flow cell provides the advantage of enabling SERS-measurements of various measurands, e.g., concentrations of different target analytes, to be performed in-line and in a continuous manner.

In this respect, the chemical inertness of the passivation layer of the SERS-substrate provides the advantage of effectively preventing any adsorption of molecules dispersed in medium that might otherwise damage or even destroy the molecules and/or that may otherwise alter or impair the medium in a manner preventing further use of the medium. It further provides the advantage that molecules can move freely through an evanescent field emanating from the illuminated SERS-substrate inside the flow channel and without fouling the SERS-substrate. This enables for SERS measurements to be continuously performed without requiring an exchange process to be performed between consecutive measurements. The passivation layer preventing adsorption further provides the advantage that impairments of the SERS-measurements due to time dependent adsorption rates are avoided.

In addition, the protection of the nanostructured layer provided by the passivation enables for the SERS-substrate to withstand adverse process conditions and enables for flow channel and the SERS-substrate to be cleaned and/or sterilized in place, e.g., by cleaning in place (CIP) and/or sterilization in place (SIP) procedures performed at the measurement site.

In certain embodiments, the nanostructured layer includes a nanostructured noble metal layer or a nanostructured gold layer; the passivation layer is a graphene layer and/or a layer having a thickness of 0.1 nm to 5.0 nm; and/or the passivation layer is disposed on the nanostructured layer.

In further embodiments, the flow cell further comprises a primary reflector; wherein:
the primary reflector is configured to reflect incident light towards the SERS-substrate;
the primary reflector is a flat reflector having a flat reflective surface, a curved reflector having a curved reflective surface, a focusing mirror reflecting incident light onto the SERS-substrate or onto a point or a line on the SERS-substrate, or a collimating mirror reflecting the incident light onto an area of the SERS-substrate; and/or
the primary reflector is given by an individual component, by a coating or by a reflective and/or polished surface of a component of the flow cell.

In further embodiments, the flow cell further comprises a secondary reflector reflecting incident light towards a section of the flow channel adjacent the SERS-substrate; wherein:
a primary reflector is disposed on one side of the flow channel and the secondary reflector is disposed opposite the primary reflector on the other side of the flow channel;
the secondary reflector is a curved reflector having curved reflective surface configured to reflect incident light towards the section of the flow channel adjacent the SERS-substrate;
the secondary reflector is given by an individual component, a coating disposed or deposited on a component of the flow cell, or by a reflective and/or polished surface of a component of the flow cell; and/or
the secondary reflector adjoins the flow channel; is disposed on, space apart from or air-spaced from a rear side facing away from the SERS-substrate of a transparent element, a transparent window frame or a transparent window extension surrounding the transmission window; is disposed on a surface or given by reflective surface surrounding the transmission window; or is disposed on a surface or given by reflective surface of the cell body, of an element, of a window frame or of a window extension surrounding the transmission window.

According to a first embodiment, the transmission window and the SERS-substrate are disposed on opposing sides of the flow channel.

According to a refinement of the first embodiment,
the SERS-substrate is disposed or deposited on a carrier, on a transparent carrier, on a disc-shaped carrier or on a carrier consisting of a solid material, a ceramic, a transparent material, a glass or sapphire; and
the carrier is disposed in an opening extending through a wall section of the cell body and/or is flush mounted inside an opening extending through a wall section of the cell body such that a surface of the carrier adjacent the flow channel is flush with an inner surface of the cell body surrounding it.

According to a further refinement of the first embodiment, the flow cell further comprises a primary reflector. In this further refinement, the SERS-substrate is disposed or deposited on a transparent carrier disposed in an opening extending through a wall section of the cell body; and the primary reflector is disposed outside the flow channel opposite the transmission window and configured to receive light propagating through the SERS-substrate and the transparent carrier to the primary reflector and to reflect the incident light towards the SERS-substrate.

According to another refinement of the first embodiment, the primary reflector is disposed on, space apart from or air-spaced from a rear side of the transparent carrier facing away from the SERS-substrate; or
the primary reflector is a curved reflector including a curved reflective surface disposed on an outer surface of a transparent extension of the transparent carrier having a shape corresponding to the curved shape of the primary reflector.

In certain refinements of the first embodiment, flow cell further comprises a secondary reflector configured to receive light propagating into an area surrounding the transmission window and to reflect incident light towards a section of the flow channel adjacent the SERS-substrate.

According to a second embodiment, the SERS-substrate is disposed or deposited on a surface of the transmission window adjacent the flow channel inside the cell body.

According to a refinement of the second embodiment, the flow cell further comprises a primary reflector configured to reflect incident light to the SERS-substrate; wherein the SERS-substrate and the primary reflector are disposed on opposite sides of the flow channel.

According to a refinement of such a refinement:
the primary reflector adjoins the flow channel and/or the primary reflector is disposed on an inner surface of the cell body or is given by a reflective inner surface or a polished inner surface of the cell body opposing the SERS-substrate;
the primary reflector is disposed on a surface of a carrier facing the SERS-substrate or given by a reflective surface of a carrier facing the SERS-substrate; wherein the carrier is disposed in an opening extending through a wall section of the cell body opposite the SERS-substrate;
the primary reflector is disposed on, spaced apart from or air-spaced from a rear side of a window the facing away from the SERS-substrate; wherein the window is disposed in an opening extending through a wall section of the cell body opposite the SERS-substrate; or
the primary reflector is a curved reflector disposed on an outer surface of a transparent extension of a window disposed in an opening extending through a wall section of the cell body opposite the SERS-substrate having a shape corresponding to the curved shape of the primary reflector.

According to a further refinement of the second embodiment, the flow cell further comprises a secondary reflector configured to receive light propagating into an area surrounding the transmission window and to reflect incident light towards a section of the flow channel adjacent the SERS-substrate.

According to a further refinement of the second embodiment, the flow cell further comprises a prism evanescently coupled to the SERS-substrate and configured to:
receive excitation light transmitted to the prism along an excitation light path outside the flow channel and to refract the received excitation light through the transmission window towards the SERS-substrate such that an evanescent field extends from the evanescently coupled SERS-substrate into the medium adjacent an outside surface of the passivation layer during measurement; and
receive measurement light including Raman scattered light emanating from the medium exposed to the evanescent field through the evanescently coupled SERS-substrate and the transmission window and to provide the measurement light along a measurement light path outside the flow channel.

The present disclosure further includes a measurement apparatus for performing surface-enhanced Raman spectroscopic measurements of at least one measurand of a medium, the measurement apparatus comprising: the flow cell disclosed herein; an excitation light source configured to provide excitation light;
an optical system configured to transmit excitation light provided by the excitation light source through the transmission window of the flow cell and to receive measurement light including Raman scattered light exiting the flow cell through the transmission window; a spectrometric unit receiving measurement light or Raman scattered light provided by the optical system and configured to determine and to provide measured spectra of the medium; and a processing unit connected to and/or communicating with the spectrometric unit and configured to determine and to provide measurement results of each measurand of the medium based on the measured spectra provided by the spectrometric unit.

In certain embodiments of the measurement apparatus the transmission window and the SERS-substrate are disposed on opposing sides of the flow channel of the flow cell; the optical system includes an objective transmitting the excitation light into the flow cell and receiving the measurement light exiting the flow cell; and the objective:
is accommodated in a probe head including a housing and a housing window disposed in a housing wall of the housing; wherein the probe head is configured to be disposed next to the flow cell such that an outside surface of the housing window adjoins or faces an outside surface of the transmission window of the flow cell; and/or
is given by:
a focusing objective focusing the excitation light onto the SERS-substrate or onto a focusing point or a focusing line on the SERS-substrate and collecting the measurement light exiting the flow cell, or
an objective configured to transmit a collimated beam of the excitation light having a given cross-sectional area smaller or equal to a surface area of the SERS-substrate towards the SERS-substrate and to collect the measurement light exiting the flow cell.

According to a further embodiment of the measurement apparatus:
the SERS-substrate is disposed or deposited on the surface of the transmission window adjacent the flow channel inside the cell body;
the optical system includes a prism configured to:
receive excitation light transmitted to the prism along an excitation light path outside the flow channel and to refract the received excitation light through the transmission window of the flow cell towards the SERS-substrate such that an evanescent field extends from the evanescently coupled SERS-substrate into the medium adjacent the SERS-substrate inside the flow channel; and
receive the measurement light including the Raman scattered light emanating from the medium during exposure to the evanescent field through the evanescently coupled SERS-substrate and the transmission window of the flow cell and to provide the measurement light along a measurement light path outside the flow channel; and
the prism is either a component of the flow cell adjoining an outside surface of the transmission window opposite the SERS-substrate or a component adjoining an inside surface of a housing window disposed in an opening of a housing wall of a housing of a probe head, wherein the probe head is configured to be disposed next to the flow cell such that an outside surface of the housing window adjoins or faces an outside surface of the transmission window of the flow cell.

In certain embodiments, the measurement apparatus further comprises a holder; wherein:
the flow cell includes a transparent window or a transparent carrier disposed in an opening extending through the wall section of the cell body opposite the transmission window; and
the holder includes two side elements delimiting a receptacle for accommodating the flow cell and an opening extending through a first one of the side elements such that it exposes the transmission window of the flow cell disposed in the holder; and a reflector disposed opposite the opening in the first side element and configured to receive light exiting the flow cell disposed in the holder through the transparent window or the transparent carrier of the flow cell and to reflect the incident light through the transparent window or the transparent carrier to the SERS-substrate;
wherein the reflector is a flat reflector having a flat reflective surface, a curved reflector having a curved reflective surface, a focusing mirror reflecting incident light onto the SERS-substrate or onto a point or a line on the SERS-substrate, or a collimating mirror reflecting the incident light onto an area of the SERS-substrate; and/or is given by an individual component attached to the second side element, by a coating disposed or deposited on the second side element, or by a reflective and/or polished surface of the second side element.

### BRIEF DESCRIPTION OF THE DRAWINGS

The described embodiments and other features, advantages and disclosures contained herein, and the manner of attaining them, will become apparent and the present disclosure will be better understood by reference to the following description of various embodiments of the present disclosure taken in junction with the accompanying drawings, wherein:

FIG. 1 shows a flow cell including a SERS-substrate on a carrier according to the present disclosure;

FIG. 2 shows a flow cell including a SERS-substrate on a transmission window;

FIG. 3 shows a flow cell including a primary reflector disposed on an outer side of a cell body;

FIG. 4 shows a flow cell including a primary reflector disposed on a transparent carrier;

FIG. 5 shows a flow cell including a primary reflector and a secondary reflector;

FIG. 6 shows a flow cell including a primary reflector disposed inside the flow cell;

FIG. 7 shows a flow cell including a primary reflector disposed on an inner surface of a carrier;

FIG. 8 shows a further flow cell including a primary reflector and a secondary reflector;

FIG. 9 shows a measurement apparatus according to the present disclosure including the flow cell shown in FIG. 1;

FIG. 10 shows a measurement apparatus including the flow cell shown in FIG. 2;

FIG. 11 shows a spectrometric unit; and

FIG. 12 shows a probe head installed on a holder accommodating a flow cell according to the present disclosure.

To visualize elements of different sizes, in particular, the extremely thin SERS-substrate, the figures use a non-scale representation.

### DETAILED DESCRIPTION

The present disclosure includes a flow cell for performing surface-enhanced Raman spectroscopic measurements of at least one measurand of a medium and includes a measurement apparatus for performing surface-enhanced Raman spectroscopic measurements comprising the flow cell.

The medium is, e.g., a liquid or gaseous medium, a colloidal medium including molecules of at least one target analyte, and/or a process medium, e.g., a process medium contained, transported, provided, processed and/or produced at a measurement site in a given application, e.g., an application in the life science industry, in bioprocessing or in the pharmaceutical industry.

Depending on the application where the flow cell and/or the measurement apparatus is employed, the at least one measurand, e.g., includes a concentration of a target analyte included in the medium, a pH-value of the medium, and/or at least one other measurand of the medium.

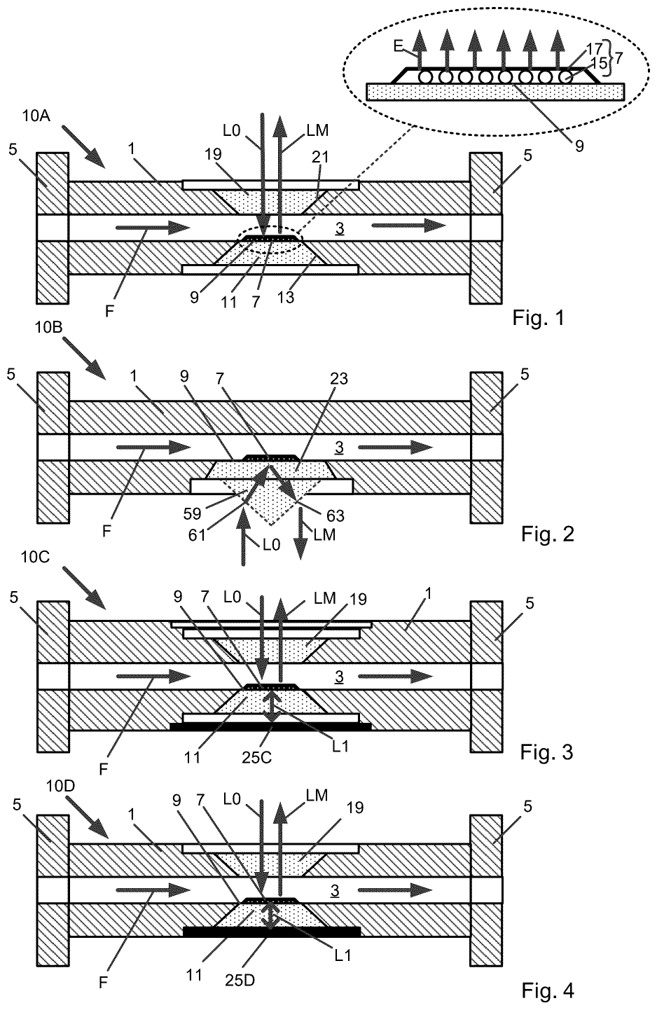

An exemplary embodiment of a flow cell 10A is shown in FIG. 1. The flow cell 10A includes a cell body 1 and a flow channel 3 extending through the cell body 1.

The cell body 1 may be configured in various ways. In certain embodiments, the cell body 1 is, e.g., a monolithic body. In other embodiments, the cell body 1 is, e.g., composed of two or more individual parts. In addition or as an alternative, in certain embodiments, the cell body 1 is, e.g., a metal body, e.g., a stainless steel body, or a plastic body, e.g., a transparent plastic body. The flow channel 3 is configured to convey the medium.

As shown in FIG. 1, in certain embodiments, the flow cell 10A, e.g., includes process connectors 5 for connecting the flow cell 10A to a process line, a supply line and/or a drain pipe.

Depending on the application where the flow cell 10A is employed, the SERS-measurements are, e.g., performed on the medium flowing through the flow cell 10A, e.g., as indicated by the direction arrows F shown in FIGS. 1-10, or on the medium contained, e.g., temporarily contained, in the flow cell 10A.

As shown in FIG. 1, the flow cell 10A further includes a SERS-substrate 7 disposed, e.g., deposited, on a surface 9 adjacent the flow channel 3 inside the cell body 1.

In the embodiment shown in FIG. 1, the surface 9 adjacent the flow channel 3 is an inner surface of a carrier 11 disposed in an opening extending through a wall section of the cell body 1.

The carrier 11 may, e.g., be secured in the opening in various ways. In FIG. 1, the cell body 1, e.g., includes an internal surface 13, e.g., a tapered internal surface, surrounding the opening and/or the carrier 11 is, e.g., sealed into the opening. The seal between the carrier 11 and wall section of the cell body 1 surrounding it is, e.g., achieved by the carrier 11 being brazed, compression bonded or press fitted into the opening. In certain embodiments, the carrier 11 is, e.g., flush mounted inside the opening such that the surface 9 of the carrier 11 adjacent the flow channel 3 is flush with an inner surface of the cell body 1 surrounding it, e.g., the inner surface defining the flow channel 3.

Considering that the SERS-substrate 7 is significantly thinner than shown in FIG. 1 for illustrative purposes, e.g., only 20 nm to 40 nm thick, the effect of the SERS-substrate 7 on the flow of the medium through the flow channel 3 is negligibly small and can be reduced even further by positioning the SERS-substrate 7 in a shallow recess in the carrier 11.

In certain embodiments, the carrier 11 is, e.g., disc-shaped, exhibiting two flat surfaces extending parallel to each other and/or consists of a solid material, e.g., a ceramic, a transparent material, e.g., a glass or sapphire, or another robust material.

As shown in the encircled detailed view within FIG. 1 of the SERS-substrate 7 disposed on the surface 9, the SERS-substrate 7 includes a nanostructured layer 15 and a transparent, chemically inert passivation layer 17 covering an outside surface of the SERS-substrate 7 adjacent the flow channel 3. The passivation layer 17 is, e.g., disposed on the nanostructured layer 15 such that it adjoins the flow channel 3 and correspondingly also the medium inside the flow channel 3.

In certain embodiments, the nanostructured layer 15 is, e.g., a nanostructured noble metal layer, e.g., a nanostructured gold layer. By means of the nanostructured geometry, a high SERS-enhancement is achieved. The nanostructured gold layer provides the advantage that gold is essentially Raman neutral. In contrast to silver substrates used in the prior devices cited herein, the nanostructured gold layer does not emit interference signals that might impair the SERS-measurements and/or reduce the measurement accuracy.

In certain embodiments, the passivation layer 17 is, e.g., a graphene layer. The graphene layer provides the advantage that it is not only optically transparent and chemically inert, but also very robust, so that already a very thin layer is sufficient to protect the nanostructured layer 15. Correspondingly, in certain embodiments, the passivation layer 17 is, e.g., a thin layer, e.g., a thin graphene layer and/or a thin layer having a thickness of 0.1 nm to 5 nm.

With respect to the SERS-substrate 7, SERS-substrates disclosed in the article titled, “Graphene-Veiled Gold Substrate for Surface-Enhanced Raman Spectroscopy,” by Weigao Xu, Jiaqi Xiao, Yanfeng Chen and Yabin Chen, published Feb. 13, 2013, volume 25, of the journal Advanced Materials, as well as SERS-substrates disclosed in the article titled, “Graphene: A Platform for Surface-enhanced Raman Spectroscopy,” by Weigao Xu, Nannan Mao and Jin Zhang, published in 2013 in volume 9 of the journal Small, are suitable and may be used.

The flow cell 10A further includes a transmission window 19 configured to permit excitation light L0 to be transmitted through the transmission window 19 to the SERS-substrate 7 inside the cell body 1. As shown in the encircled detailed view of the SERS-substrate 7 within FIG. 1, the SERS-substrate 7 receiving the excitation light L0 causes an evanescent field E to extend from the SERS-substrate 7 into the medium adjacent an outside surface of the passivation layer 17 during a measurement operation. This excites surface-enhanced Raman scattering in the medium exposed to the evanescent field E. The transmission window 19 is further configured to permit measurement light LM including Raman scattered light LR emanating from the medium inside the flow channel 3 to be received through the transmission window 19. Depending on the design of the flow cell 10A, the measurement light LM may further include at least some excitation light L0 and/or Rayleigh scattered light emanating from the medium.

In certain embodiments, the transmission window 19 is, e.g., given by a transparent wall section of the cell body 1 adjacent the flow channel 3. In alternative embodiments, the transmission window 19 is, e.g., an individual component, e.g., a disc-shaped component exhibiting two parallel flat surface, consisting of a transparent material, e.g., a glass or sapphire. In these embodiments, the transmission window 19 is, e.g., disposed in an opening extending through a wall section of the cell body 1.

The transmission window 19 may be secured in the opening in various ways. In FIG. 1, the cell body 1, e.g., includes an internal surface 21, e.g., a tapered internal surface, surrounding the opening accommodating the transmission window 19. In addition or as an alternative a seal between the transmission window 19 and the wall section of the cell body 1 surrounding it is, e.g., achieved by the transmission window 19 being brazed, compression bonded or press fitted into the opening. In certain embodiments, the transmission window 19 is, e.g., flush mounted inside the opening such that a surface of the transmission window 19 adjacent the flow channel 3 is flush with an inner surface of the cell body 1 surrounding it, e.g., the inner surface defining the flow channel 3.

In FIG. 1, the transmission window 19 and the SERS-substrate 7 are disposed on opposing sides of the flow channel 3. In this embodiment, the excitation light L0 is transmitted to the SERS-substrate 7 through the transmission window 19 and the medium inside the flow channel 3 and the measurement light LM exits the flow channel 3 through the medium and the transmission window 19.

FIG. 2 shows an alternative embodiment of a flow cell 10B including the cell body 1, the flow channel 3 and the SERS-substrate 7 described above, wherein the SERS-substrate 7 is disposed, e.g., deposited, on a surface of a transmission window 23 adjacent the flow channel 3 inside the cell body 1. The transmission window 23 is configured to permit excitation light L0 to be transmitted through the transmission window 23 to the SERS-substrate 7 inside the cell body 1 and to permit measurement light LM including Raman scattered light LR emanating from the medium inside the flow channel 3 to be received through the transmission window 23. In FIG. 2, the excitation light L0 is transmitted through the transmission window 23 to the backside of the SERS-substrate 7 facing away from the flow channel 3 such that it causes the evanescent field E to extend from the SERS-substrate 7 into the medium adjacent an outside surface of the passivation layer 17 inside the flow channel 3 and measurement light LM including Raman scattered light LR emanating from the medium exposed to the evanescent field E exits the flow channel 3 through the SERS-substrate 7 and the transmission window 23.

The transmission window 23 constitutes a transparent SERS-substrate carrier and is, e.g., secured in and/or sealed into an opening extending through a wall section the cell body 1 as described above with respect to the carrier 11 and/or the transmission window 19 shown in FIG. 1.

The flow cells 10A, 10B disclosed herein provide the advantages mentioned above. Individual components of the flow cell 10A, 10B may be implemented in various ways without deviating from the scope of the invention. Several further embodiments are described in more detail below.

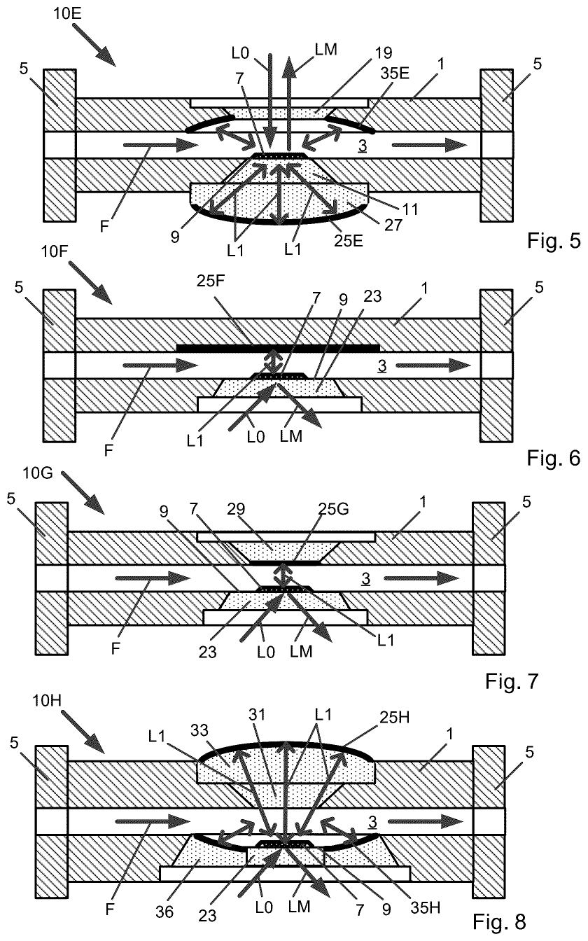

In certain embodiments, flow cells configured as described above may additionally include a primary reflector configured to reflect incident light towards the SERS-substrate 7. Exemplary embodiments are shown in FIGS. 3-8. Depending on the design of the flow cell 10C, 10D, 10E, 10F, 10G, 10H, the primary reflector 25C, 25D, 25E, 25F, 25G, 25H is, e.g., a flat reflector having a flat reflective surface, e.g., as shown in FIGS. 3, 4, 6 and 7, or a curved reflector having a curved reflective surface, e.g., as shown in FIGS. 5 and 8. In the latter case, the primary reflector 25E, 25H is, e.g., a focusing mirror adapted to focus incident light onto the SERS-substrate 7, e.g., onto a point or a line on the SERS-substrate 7. As an alternative, the primary reflector 25E, 25H is, e.g., a collimating mirror reflecting the incident light onto an area of the SERS-substrate 7, e.g., an area smaller or equal to a base-area of the SERS-substrate 7.

Depending on the configuration, e.g., the position and/or the shape, of the primary reflector 25C, 25D, 25E, 25F, 25G, 25H, the primary reflector 25C, 25D, 25E, 25F, 25G, 25H is, e.g., given by an individual component, by a coating, or by a reflective and/or polished surface of a component of the flow cell 10C, 10D, 10E, 10F, 10G, 10H.

The flow cells 10C, 10D, 10E shown in FIGS. 3-5 are embodiments of the flow cell 10A shown in FIG. 1, wherein the carrier 11 with the SERS-substrate 7 is a transparent carrier, and the primary reflector 25C, 25D, 25E is disposed outside the flow channel 3 and opposite the transmission window 19. This results in the SERS-substrate 7 being positioned between the transmission window 11 and the primary reflector 25C, 25D, 25E. In these embodiments, the primary reflector 25C, 25D, 25E is configured to receive light L1 propagating through the SERS-substrate 7 and the transparent carrier 11 to the primary reflector 25C, 25D, 25E and to reflect the incident light L1 towards the SERS-substrate 7. When excitation light L0 is transmitted through the transmission window 19 to the SERS-substrate 7 the light L1 received by the primary reflector 25C, 25D, 25E includes a fraction of the excitation light L0 transmitted through the transmission window 19 to the SERS-substrate 7 that passes through the SERS-substrate 7 and the transparent carrier 11 to the primary reflector 25C, 25D, 25E and a fraction of Raman scattered light LR emanating from the medium inside the flow channel 3 that passes through the SERS-substrate 7 and the transparent carrier 11 to the primary reflector 25C, 25D, 25E.

The primary reflector 25C, 25D, 25E reflecting the received fraction of the excitation light L0 back to the SERS-substrate 7 results in a backside illumination of the SERS-substrate 7 which amplifies the evanescent field E extending from the SERS-substrate 7 into the medium adjacent the SERS-substrate 7 inside the flow channel 3. This in turn increases the amount of Raman scattered light LR emanating from the medium and correspondingly also the amount of Raman scattered light LR exiting the flow cell 10C, 10D, 10E through the transmission window 19.

The primary reflector 25C, 25D, 25E reflecting the incident fraction of the Raman scattered light LR provides the advantage that at least a fraction of the reflected Raman scattered light passes through the SERS-substrate 7 towards the transmission window 19. Both effects increase the signal intensity of the Raman scattered light LR exiting the flow cell 10C, 10D, 10E through the transmission window 19.

The primary reflector 25C, 25D, 25E can be designed and/or positioned in various ways.

FIG. 3 shows an embodiment, wherein the primary reflector 25C is spaced apart, e.g., air-spaced, from a rear side of the transparent carrier 11 facing away from the SERS-substrate 7. FIG. 4 shows an embodiments, wherein the primary reflector 25D is disposed on the rear side of the transparent carrier 11 facing away from the SERS-substrate 7. In the examples shown in FIGS. 3 and 4, the primary reflectors 25C, 25D are flat reflectors having a flat reflective surface.

In FIG. 5, the primary reflector 25E is a curved reflector having a curved reflective surface, e.g., a focusing mirror or a collimating mirror configured as outlined above. In either case, the curved reflector may be disposed on or spaced apart, e.g., air-spaced, from a rear side of the transparent carrier 11.

FIG. 5 shows an alternative embodiment, wherein the primary reflector 25E is disposed on an outer surface of a transparent extension 27 of the transparent carrier 11. In this embodiment, the outer surface of the transparent extension 27, e.g., exhibits a shape corresponding to the curved shape of the reflective surface of the primary reflector 25E and/or the primary reflector 25E is, e.g., given by a reflective coating disposed or deposited on the outer surface of the extension 27.

The flow cells 10F, 10G, 10H shown in FIGS. 6-8 are embodiments of the flow cell 10B shown in FIG. 2, wherein the SERS-substrate 7 and the primary reflector 25F, 25G, 25H are disposed on opposite sides of the flow channel 3. When excitation light L0 is transmitted through the transmission window 23 to the SERS-substrate 7 the light L1 received by the respective primary reflector 25F, 25G, 25H shown in FIGS. 6-8 includes a fraction of the excitation light L0 transmitted through the transmission window 23 that passes through the SERS-substrate 7 and the flow channel 3 to the primary reflector 25F, 25G, 25H and a fraction of Raman scattered light LR emanating from the medium inside the flow channel 3 propagating through the flow channel 3 to the primary reflector 25F, 25G, 25H.

The primary reflector 25F, 25G, 25H reflecting the received fraction of the excitation light L0 back to the SERS-substrate 7 results in a frontside illumination of the SERS-substrate 7, which amplifies the evanescent field E extending from the SERS-substrate 7 into the medium adjacent the SERS-substrate 7 inside the flow channel 3. This in turn increases the amount of Raman scattered light LR emanating from the medium and correspondingly also the amount of Raman scattered light LR exiting the flow cell 10F, 10G, 10H through the transmission window 23.

The primary reflector 25F, 25G, 25H reflecting the incident fraction of the Raman scattered light LR provides the advantage that at least a fraction of the reflected Raman scattered light passes through the flow channel 3, the SERS-substrate 7 and the transmission window 23. Both effects increase the signal intensity of the Raman scattered light LR exiting the flow cell 10F, 10G, 10H through the transmission window 23.

The primary reflectors 25F, 25G, 25H shown in FIGS. 6-8 can be designed and/or positioned in various ways. In FIG. 6, the primary reflector 25F adjoins the flow channel 3. In this embodiment, the primary reflector 25F is, e.g., disposed on an inner surface of the cell body 1 or given by a reflective inner surface, e.g., a polished inner surface, of the cell body 1 opposing the SERS-substrate 7.

In FIG. 7, the flow cell 25G further includes a carrier 29 disposed in an opening extending through a wall section of the cell body 1 opposite the SERS-substrate 7 and the primary reflector 25G is disposed on a surface of the carrier 29 or given by a reflective surface of the carrier 29 facing the SERS-substrate 7.

In FIG. 8 the flow cell 10H includes a transparent window 31 disposed in an opening extending through a wall section of the cell body 1 opposite the SERS-substrate 7.

In combination with transparent window 31 the primary reflector is, e.g., disposed on, or spaced apart, e.g., air-spaced, from a rear surface of the window 31 facing away from the SERS-substrate 7.

FIG. 8 shows an alternative embodiment, wherein the primary reflector 25H is disposed on an outer surface of a transparent extension 33 of the transparent window 31. In the embodiment shown, the primary reflector 25H is a curved reflector, e.g., a focusing mirror or a collimating mirror configured as described above. In this case, the outer surface of the transparent extension 33, e.g., exhibits a shape corresponding to the curved shape of the reflective surface of the primary reflector 25H and/or the primary reflector 25H is, e.g., given by a reflective coating disposed or deposited on the outer surface of the transparent extension 33.

In certain embodiments, the flow cell 10E, 10H, e.g., includes a secondary reflector reflecting incident light towards a section of the flow channel 3 adjacent the SERS-substrate 7. This is illustrated in FIGS. 5 and 8, showing embodiments of flow cells 10E, 10H including the primary reflector 25E, 25H disposed on one side of the flow channel 3 and a secondary reflector 35E, 35H disposed opposite the primary reflector 25E, 25H on the other side of the flow channel 3.

In the exemplary embodiments shown, the secondary reflector 35E, 35H adjoins the flow channel 3. In this case the secondary reflector 35E, 35 His, e.g., disposed on a surface or given by reflective surface surrounding the transmission window 19, 23. As shown in FIG. 5, in certain embodiments, this is, e.g., achieved by the secondary reflector 35E being disposed on a surface or given by reflective surface of the cell body 1 surrounding the transmission window 19. FIG. 8 shows an alternative embodiment, wherein the secondary reflector 35H is disposed on a surface or given by reflective surface of an element 36, e.g., a window frame or a window extension, surrounding the transmission window 23. As another alternative, available when the element 36 is transparent, the secondary reflector is, e.g., disposed on, space apart from or air-spaced from a rear side of the element 36 facing away from the SERS-substrate.

As shown in FIGS. 5 and 8, in certain embodiments, the secondary reflector 35E, 35H is, e.g., a curved reflector configured to reflect incident light towards the section of the flow channel 3 adjacent the SERS-substrate 7.

Regardless of whether the flow cell 10E, 10H includes the primary reflector 25E, 25H, the secondary reflector 35E, 35H provides the advantage that it further amplifies the excitation light L0 and/or the evanescent field E interacting with the medium and that it increases the amount of Raman scattered light LR emanating from the medium in the flow channel 3 that exits the flow cell 10E, 10H through the transmission window 19, 23.

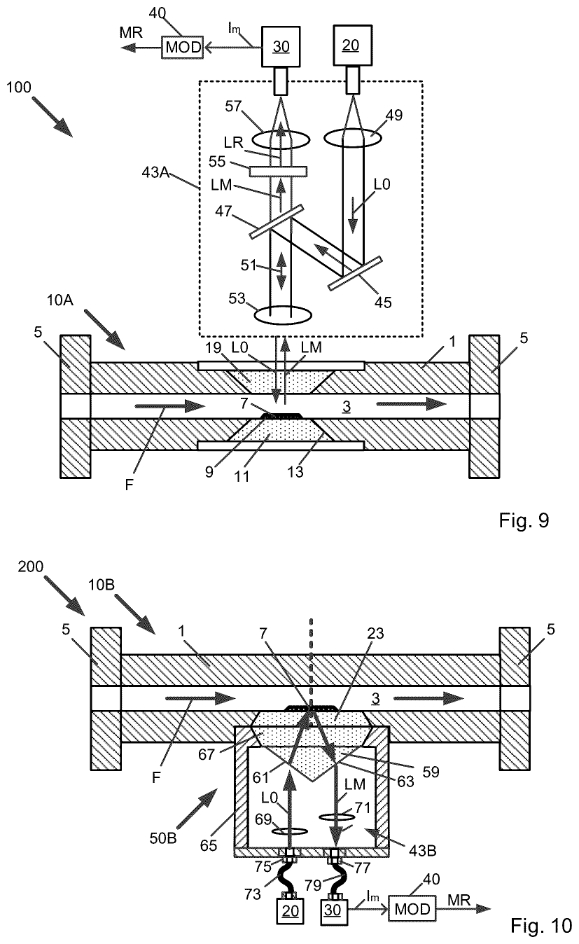

A further aspect of the present disclosure includes a measurement apparatus for performing SERS-measurements comprising the flow cell disclosed herein, e.g., one of the flow cells 10A to 10H shown in FIGS. 1-8. FIG. 9 shows an exemplary embodiment of a measurement apparatus 100, which includes the flow cell 10A shown in FIG. 1. FIG. 10 shows an exemplary embodiment of a measurement apparatus 200, which includes the flow cell 10B shown in FIG. 2. Each measurement apparatus 100, 200 comprises an excitation light source 20 configured to generate and transmit excitation light L0 through the transmission window 19, 23 of the flow cell 10A, 10B to the SERS-substrate 7, a spectrometric unit 30 receiving the measurement light LM or the Raman scattered light LR included in the measurement light LM exiting the flow cell 10A, 10B through the transmission window 19, 23, and a processing unit 40, e.g., a computer with a memory, a microprocessor or another type of signal and/or data processing unit, connected to and/or communicating with the spectrometric unit 30.

The excitation light source 20 is preferably a monochromatic light source, e.g., a laser, generating excitation light L0 having a predetermined excitation wavelength, e.g., a wavelength in the visual or near infrared wavelengths range, e.g., a wavelength between 400 nm and 1200 nm.

The spectrometric unit 30 is configured to determine and provide measured spectra Iₘ of the medium based on the received measurement light LM or the received Raman scattered light LR.

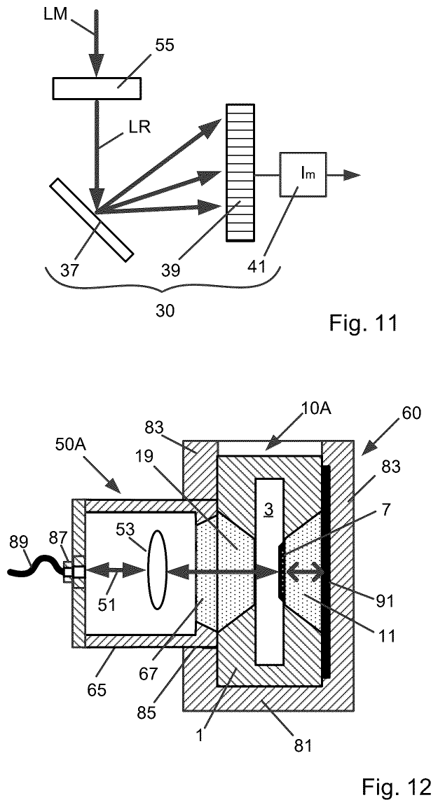

An exemplary embodiment of the spectrometric unit 30 is shown in FIG. 11. As shown, this spectrometric unit 30, e.g., includes a disperser 37, e.g., a diffractive or holographic grating, dispersing incident light, a detector 39 receiving the dispersed light and a signal processor 41, e.g., a microprocessor, connected to the detector 39 and configured to determine and to provide the measured spectra Iₘ. In this respect, the detector 39 is, e.g., configured to determine intensities and to generate detector signals corresponding to spectral intensities of the incident dispersed light and the signal processor 41 is, e.g., configured to determine and to provide intensity values of the measured spectra Iₘ based on the detector signals. In certain embodiments, the detector 39, e.g., includes an array of detection elements, e.g., an array of charge coupled devices (CCD) or an array of photodiodes, each receiving a fraction of the dispersed light and determining and providing a detector signal corresponding to the intensity of the received fraction, e.g., the number of photons received in time periods of a given duration, to the signal processor 41.

The processing unit 40 is configured to determine and to provide measurement results MR of at least one measurand of the medium, e.g., a concentration of at least one target analyte included in the medium, based on the measured spectra Iₘ provided by the spectrometric unit 30, e.g., based on a previously determined model MOD, e.g., stored in the memory, for determining measurement results MR of the respective measurand based on spectral intensity values of the measured spectra Iₘ.

Depending on the application in which the measurement apparatus 100, 200 is employed, the measurement results MR of the or each measurand are, e.g., employed to monitor, to regulate and/or to control a process performed at the application and/or to monitor and/or to control the quality of products processed and/or produced at the respective application.

The measurement apparatus 100, 200 provides the advantages mentioned above in context with the flow cells 10A, 10B, 10C, 10D, 10E, 10F, 10G, 10H disclosed herein. Individual components measurement apparatus 100, 200 may be implemented in different ways without deviating from the scope of the invention. Several optional embodiments are described in more detail below.

In certain embodiments, the measurement apparatus 100, 200, e.g., includes an optical system 43A, 43B configured to transmit the excitation light L0 provided by the excitation light source 20 to the transmission window 19, 23 of the flow cell 10A, 10B, to receive the measurement light LM exiting the flow cell 10A, 10B, and to provide the measurement light LM or the Raman scattered light LR included in the measurement light LM to the spectrometric unit 30.

To this extent, the optical system 43A, 43B, e.g., includes a suitable arrangement of optical components, e.g., lenses, mirrors, filters and/or optical fibers, configured to transmit the excitation light L0, the measurement light LM and/or the Raman scattered light LR. The optical system 43A, 43B, e.g., includes one or several parts, e.g., a signal transmission optic performing at least a part of transmitting the excitation light L0 to the flow cell 10A, 10B, a signal reception optic performing at least a part of receiving the measurement light LM and/or of providing the measurement light LM or the Raman scattered light LR to the spectrometric unit 30, and/or a combined signal transmission and reception optic performing at least a part of these tasks. The optical system 43A, 43B is, e.g., connected to the excitation light source 20 and/or the spectrometric unit 30 via an open path geometry and/or via an optical fiber. In addition or as an alternative, in certain embodiments individual parts of the optical system 43A, 43B are, e.g., interconnected via an open path geometry and/or via an optical fiber.

FIG. 9 shows an embodiment, wherein the optical system 43A includes a mirror 45 reflecting excitation light L0 provided to the optical system 43A onto a beam combiner 47. The excitation light L0 is, e.g., provided to the optical system 43A directly or via an optical fiber. In the latter case, the optical system 43A, e.g., includes an excitation lens 49 collimating the excitation light L0 provided via the optical fiber onto the mirror 45. In either case, the beam combiner 47 directs the excitation light L0 along a counter-propagating path 51 to an objective 53 directing the excitation light L0 through the transmission window 19 to the SERS-substrate 7 and receiving the measurement light LM exiting the flow cell 10A through the transmission window 19. The measurement light LM received by the objective 53 then returns along the counter-propagating path 51 through the beam combiner 47 towards the spectrometric unit 30.

In certain embodiments, the objective 53 is, e.g., a focusing objective adapted to focus the excitation light L0 onto the SERS-substrate 7 and collecting the measurement light LM exiting the flow cell 10A. In this case, the objective 53 is, e.g., configured to focus the excitation light L0 onto the SERS-substrate 7, e.g., onto a focusing point or a focusing line on the SERS-substrate 7.

As an alternative, the objective 53 is, e.g., an objective configured to transmit a collimated beam of the excitation light L0 having a given cross-sectional area smaller or equal to a surface area of the SERS-substrate 7 towards the SERS-substrate 7 and to collect the measurement light LM exiting the flow cell 10A. This embodiment provides the advantage that a larger area of the SERS-substrate 7 corresponding to the cross-sectional area of the collimated beam is illuminated. This increases volume inside the flow channel 3 exposed to the evanescent field E generated by the illuminated SERS-substrate 7. This advantageous effect is, e.g., used to increase the intensity of the Raman scattered light LR exiting the flow cell 10A or to reduce the intensity of the excitation light L0 transmitted into the flow cell 10A. The latter is particularly advantageous in applications, where high intensity excitation light L0 may have an adverse effect on the medium, e.g., because it may lead to an increase of the temperature of the medium.

In certain embodiments, the measurement apparatus 100, e.g., includes a filter 55, e.g., a notch-filter, receiving the measurement light LM, attenuating light included in the incent measurement light LM having wavelengths in a limited wavelengths range including the excitation wavelength of the excitation light L0, and allowing the Raman shifted Raman scattered light LR to pass on to the spectrometric unit 30. In the example shown in FIG. 9, the filter 55 receives the measurement light LM returning along the counter propagation path 51 and passes the Raman scattered light LR to the spectrometric unit 30, e.g., directly or via a focusing lens 57 focusing the Raman scattered light LR onto a collection fiber transmitting the Raman scattered light LR to the spectrometric unit 30.

In embodiments, wherein the SERS-substrate 7 is disposed on the surface 9 of the transmission window 23 adjacent the flow channel 3, e.g., as shown in FIGS. 2 and 10, the optical system 43B preferably includes a prism 59 configured to receive excitation light L0 transmitted to the prism 59 along an excitation light path outside the flow channel 3 and to refract the received excitation light L0 through the transmission window 23 towards the SERS-substrate 7 such that an evanescent field E extends from the evanescently coupled SERS-substrate 7 into the medium adjacent the SERS-substrate 7 inside the flow channel 3. The prism 59 is further configured to receive measurement light LM including Raman scattered light LR emanating from the medium exposed to the evanescent field E through the evanescently coupled SERS-substrate 7 and the transmission window 23 and to provide the received measurement light LM along a measurement light path outside the flow channel 3.

To this extent, the prism 59, e.g., includes a reception surface 61 receiving the excitation light L0 transmitted to the prism 59 along the excitation light path extending from the excitation light source 20 to the prism 59 and refracting the incident excitation light L0 through the transmission window 23 towards the SERS-substrate 7. As shown in FIGS. 2 and 10, the prism 59 further includes a transmission surface 63 refracting measurement light LM received by the prism 59 through the evanescently coupled SERS-substrate 7 and the transmission window 23 onto the measurement light path extending from the prism 59 towards the spectrometric unit 30.

In certain embodiments, the prism 59, e.g., constitutes a component of the flow cell 10B. In these embodiments, the prism 59, e.g., adjoins an outside surface of the transmission window 23 opposite the SERS-substrate 7, e.g., as indicated by the dotted line shown in FIG. 2. In these embodiments, the prism 59 and the transmission window 23 are, e.g., individual parts or given by a monolithic element including the prism 59 and the transmission window 23. In either case, the prism 59 and the transmission window 23, e.g., consist of the same transparent material.

FIG. 10 shows an alternative embodiment, wherein the prism 59 is accommodated in a probe head 50B including a housing 65 and a housing window 67 inserted in an opening in a housing wall of the housing 65. In FIG. 10, the prism 59 adjoins an inner surface of the housing window 67 and the probe head 50B is configured to be disposed next to the flow cell 10B such that the housing window 67 adjoins or faces an outside surface of the transmission window 23 of the flow cell 10B.

The prism 59 and the housing window 65 are, e.g., individual parts or given by a monolithic element including the prism 59 and the housing window 67. In either case, the prism 59 and the housing window 67, e.g., consist of the same transparent material, e.g., the same transparent material as the transmission window 23 of the flow cell 10B.

Regardless of whether the prism 59 constitutes a part of the flow cell 10B or an external part, in certain embodiments, the optical system 43B additionally includes a signal transmission optic receiving the excitation light L0 provided by the excitation light source 20 directly or via an optical fiber and providing the received excitation light L0 to the prism 59 along the excitation light path. As illustrated in FIG. 10, the signal transmission optic, e.g., includes a collimation lens 69 collimating the excitation light L0 towards the reception surface 61 of the prism 59. In addition or as an alternative the optical system 43B, e.g., includes a signal reception optic receiving the measurement light LM from the prism 59 along the measurement path and transmitting the received measurement light LM towards the spectrometric unit 30. As illustrated in FIG. 10, the signal reception optic, e.g., includes a collecting lens 71 providing the received measurement light LM. As shown in FIG. 10, in certain embodiments, the excitation light L0 provided by the excitation light source 20 is, e.g., provided to the signal transmission optic inside the probe head 50B via an optical fiber 73 connecting the excitation light source 20 with an input port 75 of the probe head 50B, and/or the measurement light LM provided by the signal reception optic inside the probe head 50B is, e.g., provided to the spectrometric unit 30 via an output port 77 of the probe head 50B and an optical fiber 79 connecting the output port 77 to the spectrometric unit 30.

Just like the measurement apparatus 100 shown in FIG. 9, the measurement apparatus 200 shown in FIG. 10 may also include the filter 55, e.g., the notch-filter, described above. In certain embodiments, the filter 55 is, e.g., disposed inside the probe head 50B, e.g., between the prism 59 and the collecting lens 71 of the signal reception optic or outside the probe head 50B, e.g., between the probe head 50B and the spectrometric unit 30. As an alternative shown in FIG. 11, the filter 55 is, e.g., disposed between the optical system 43B and the spectrometric unit 30.

In certain embodiments, the measurement apparatus 100, 200 disclosed herein may further include a holder for accommodating the flow cell. An exemplary embodiment of a holder 60 accommodating the flow cell 10A shown in FIG. 1 is shown in FIG. 12. The holder 60 shown may also be used in combination with other embodiments of the flow cell disclosed herein.

As shown in FIG. 12, in certain embodiments, the holder 60, e.g., includes a base 81 and two side elements 83 delimiting a receptacle accommodating the flow cell 10A. The holder 60 further includes an opening 85 extending through a first one of the two side elements 83. The opening 85 is positioned and dimensioned such that it exposes the transmission window 19 of the flow cell 10A disposed in the holder 60.

The holder 60 is, e.g., configured to be used in combination with a probe head of the measurement system 100, 200, e.g., the probe head 50B shown in FIG. 10 or the probe head 50A shown in FIG. 12 also including the housing 65 and the housing window 67 described above.

In this case, the respective probe head 50A, 50B is, e.g., permanently attached to or configured to be mounted on the holder 60, e.g., by means of corresponding mounting means, e.g., a clamp or a fastener, for mounting the probe head 50A, 50B such that the housing window 67 adjoins or faces the transmission window 19, 23 of the flow cell 10A, 10B disposed in the holder 60.

As shown in FIGS. 10 and 11, the probe head 50A, 50B is preferably configured to provide the excitation light L0 to the flow cell 10A, 10B and to receive measurement light LM exiting the flow cell 10A, 10B. In this case, at least one component of the optical system 43A, 43B, e.g., the objective 53 shown in FIGS. 9 and 12 or the prism 59 shown in FIG. 10 is disposed inside the probe head 50A, 50B.

In FIG. 10 the optical system 43B is accommodated inside the probe head 50B and connected to the excitation light source 20 and the external spectrometric unit 30 as described above.

In FIG. 12 only the objective 53 of the optical system 43A shown in FIG. 9 is disposed inside the probe head 50A including a bidirectional signal transmission port 87 for connecting an optical fiber 89 transmitting the excitation light L0 from the beam combiner 47 to the objective 53 and transmitting the measurement light LM from objective 53 to the beam combiner 47.

In certain embodiments, the holder 60 may further include a reflector 91 disposed opposite the opening 85 in the first side element 83. As shown in FIG. 12 based on the example of the flow cell 10A shown in FIG. 1, the reflector 91 is particularly useful in combination with flow cells including the transparent window 31 or the transparent carrier 11, 29 disposed in the opening extending through the wall section of the cell body 1 opposite the transmission window 19, 23, e.g., as shown in FIGS. 1, 3, 4, 5, 7 and 8. When the flow cell 10A shown in FIGS. 1 and 12 or a flow cell corresponding to the one the flow cells 10C, 10D, 10E, 10G, 10H shown in FIGS. 3, 4, 5, 7 and 8 manufactured without the primary reflector 25C, 25D, 25E, 25G, 25H is disposed in the holder 60, the reflector 91 of the holder 60 takes over the function of the primary reflectors 25C, 25D, 25E, 25G, 25H described in context with FIGS. 3, 4, 5, 7 and 8, e.g., on its own or in combination with the secondary reflector 35E, 35H of the flow cell 10E, 10H.

In analogy to the primary reflectors 25C, 25D, 25E, 25G, 25H described above and as shown in FIG. 12, the reflector 91 of the holder 60 is, e.g., configured to receive light exiting the flow cell 10A disposed in the holder 60 through the transparent window 31 or the transparent carrier 11, 29 opposite the transmission window 19, 23 and to reflect the incident light through the transparent window 31 or the transparent carrier 11, 29 to the SERS-substrate 7.

In certain embodiments, the reflector 91 of the holder 60 is, e.g., a flat reflector having a flat reflective surface as shown in FIG. 12. As an alternative the reflector 91 of the holder 60 is e. g, a curved reflector having a curved reflective surface, e.g., a focusing mirror focusing incident light onto the SERS-substrate 7, e.g., onto a point or a line on the SERS-substrate 7, or a collimating mirror collimating the incident light onto an area of the SERS-substrate 7. In addition or as an alternative, the reflector 91 of the flow cell holder 60 is, e.g., given by an individual component attached to the second side element 83, by a coating disposed or deposited on the second side element 83, or by a reflective and/or polished surface of the second side element 83.

Incorporating the reflector 91 in the flow cell holder 60 is particularly advantageous in applications, wherein the flow cell 10A is employed as a single use component, as well as in application, wherein the expected maximum operating time of the flow cell 10A may be shorter than the expected maximum operating time of the holder 60, e.g., due to adverse measurement conditions the flow channel 3 may be exposed to during operation. In both cases, it reduces the costs, because the flow cell 10A can be manufactured without primary reflector, and the flow cell holder 60 including the reflector 91 can be operated for a long time and/or in multiple applications.

We claim:

1. A flow cell for performing surface-enhanced Raman spectroscopic (SERS) measurements of at least one measurand of a medium, the flow cell comprising:
a cell body including a flow channel extending through the cell body and configured to convey the medium;
a SERS-substrate disposed on a surface adjacent the flow channel inside the cell body, the SERS-substrate comprising a nanostructured layer and a transparent, chemically inert passivation layer covering an outside surface of the SERS-substrate adjacent the flow channel; and
a transmission window configured to permit excitation light to be transmitted through the transmission window to the SERS-substrate inside the cell body and to permit measurement light, including Raman scattered light emanating from the medium inside the flow channel, to be received through the transmission window.

2. The flow cell according to claim 1, wherein, at least one of:
the nanostructured layer includes a nanostructured noble metal layer or a nanostructured gold layer;
the passivation layer is a graphene layer and/or a layer having a thickness of 0.1 nm to 5.0 nm; and
the passivation layer is disposed on the nanostructured layer.

3. The flow cell according to claim 1, further comprising a primary reflector, wherein, at least one of:
the primary reflector is configured to reflect incident light towards the SERS-substrate;
the primary reflector is a flat reflector including a flat reflective surface, a curved reflector including a curved reflective surface, a focusing mirror configured to reflect incident light onto the SERS-substrate or onto a point or a line on the SERS-substrate, or a collimating mirror configured to reflect the incident light onto an area of the SERS-substrate; and
the primary reflector is given by an individual component, by a coating, or by a reflective and/or polished surface of a component of the flow cell.

4. The flow cell according to claim 3, further comprising a secondary reflector configured to reflect incident light towards a section of the flow channel adjacent the SERS-substrate, wherein, at least one of:
the primary reflector is disposed on one side of the flow channel, and the secondary reflector is disposed opposite the primary reflector on another side of the flow channel;
the secondary reflector is a curved reflector including curved reflective surface configured to reflect incident light towards the section of the flow channel adjacent the SERS-substrate;
the secondary reflector is given by an individual component, a coating disposed or deposited on a component of the flow cell, or by a reflective and/or polished surface of a component of the flow cell; and
the secondary reflector:
adjoins the flow channel;
is disposed on, spaced apart from, or air-spaced from a rear side, facing away from the SERS-substrate, of a transparent element, a transparent window frame, or a transparent window extension surrounding the transmission window;
is disposed on a surface or given by a reflective surface surrounding the transmission window; or
is disposed on a surface or given by a reflective surface of the cell body, of an element, of a window frame, or of a window extension surrounding the transmission window.

5. The flow cell according to claim 1, wherein the transmission window and the SERS-substrate are disposed on opposing sides of the flow channel.

6. The flow cell according to claim 5, wherein:
the SERS-substrate is disposed or deposited on a carrier, on a transparent carrier, on a disc-shaped carrier, or on a carrier consisting of a solid material, a ceramic, a transparent material, a glass, or sapphire; and
the carrier is disposed in an opening extending through a wall section of the cell body and/or is flush mounted inside an opening extending through a wall section of the cell body such that a surface of the carrier adjacent the flow channel is flush with an inner surface of the cell body defining the flow channel.

7. The flow cell according to claim 5, further comprising a primary reflector, wherein:
the SERS-substrate is disposed or deposited on a transparent carrier disposed in an opening extending through a wall section of the cell body; and
a primary reflector is disposed outside the flow channel opposite the transmission window and configured to receive light propagating through the SERS-substrate and the transparent carrier to the primary reflector and to reflect the incident light towards the SERS-substrate.

8. The flow cell according to claim 5, wherein:
a primary reflector is disposed on, space apart from, or air-spaced from a rear side of the transparent carrier facing away from the SERS-substrate; or
the primary reflector is a curved reflector including a curved reflective surface disposed on an outer surface of a transparent extension of the transparent carrier having a shape corresponding to the curved shape of the primary reflector.

9. The flow cell according to claim 5, further comprising a secondary reflector configured to receive light propagating into an area surrounding the transmission window and to reflect incident light towards a section of the flow channel adjacent the SERS-substrate.

10. The flow cell according to claim 1, wherein the SERS-substrate is disposed or deposited on a surface of the transmission window adjacent the flow channel inside the cell body.

11. The flow cell according to claim 10, further comprising a primary reflector configured to reflect incident light to the SERS-substrate, wherein the SERS-substrate and the primary reflector are disposed on opposite sides of the flow channel.

12. The flow cell according to claim 11, wherein:
the primary reflector adjoins the flow channel and/or the primary reflector is disposed on an inner surface of the cell body or is given by a reflective inner surface or a polished inner surface of the cell body opposing the SERS-substrate;
the primary reflector is disposed on a surface of a carrier facing the SERS-substrate or given by a reflective surface of a carrier facing the SERS-substrate, wherein the carrier is disposed in an opening extending through a wall section of the cell body opposite the SERS-substrate;
the primary reflector is disposed on, spaced apart from, or air-spaced from a rear side of a window the facing away from the SERS-substrate, wherein the window is disposed in an opening extending through a wall section of the cell body opposite the SERS-substrate; or
the primary reflector is a curved reflector disposed on an outer surface of a transparent extension of a window disposed in an opening extending through a wall section of the cell body opposite the SERS-substrate having a shape corresponding to the curved shape of the primary reflector.

13. The flow cell according to claim 10, further comprising a secondary reflector configured to receive light propagating into an area surrounding the transmission window and to reflect incident light towards a section of the flow channel adjacent the SERS-substrate.

14. The flow cell according to claim 10, further comprising a prism evanescently coupled to the SERS-substrate and configured to:
receive excitation light transmitted to the prism along an excitation light path outside the flow channel and to refract the received excitation light through the transmission window towards the SERS-substrate such that an evanescent field extends from the evanescently coupled SERS-substrate into the medium adjacent an outside surface of the passivation layer during a measurement operation; and
receive measurement light including Raman scattered light emanating from the medium exposed to the evanescent field through the evanescently coupled SERS-substrate and the transmission window and to provide the measurement light along a measurement light path outside the flow channel.

15. A measurement apparatus for performing surface-enhanced Raman spectroscopic measurements of at least one measurand of a medium, the measurement apparatus comprising:
the flow cell according to claim 1;
an excitation light source configured to generate excitation light;
an optical system configured to transmit excitation light from the excitation light source through the transmission window of the flow cell and to receive measurement light, including Raman scattered light, exiting the flow cell through the transmission window;
a spectrometric unit configured to receive the measurement light or the Raman scattered light from the optical system and configured to determine and to provide measured spectra of the medium; and
a processing unit connected to and/or communicating with the spectrometric unit and configured to determine and to provide measurement results of each measurand of the medium based on the measured spectra provided by the spectrometric unit.

16. The measurement apparatus according to claim 15, wherein:
the transmission window and the SERS-substrate are disposed on opposing sides of the flow channel of the flow cell;
the optical system includes an objective adapted to transmit the excitation light into the flow cell and to receive the measurement light exiting the flow cell; and
the objective is:
accommodated in a probe head including a housing and a housing window disposed in a housing wall of the housing; wherein the probe head is configured to be disposed next to the flow cell such that an outside surface of the housing window adjoins or faces an outside surface of the transmission window of the flow cell; and/or
given by:
a focusing objective adapted to focus the excitation light onto the SERS-substrate or onto a focusing point or a focusing line on the SERS-substrate and to collect the measurement light exiting the flow cell, or
an objective configured to transmit a collimated beam of the excitation light, having a given cross-sectional area smaller or equal to a surface area of the SERS-substrate, towards the SERS-substrate and to collect the measurement light exiting the flow cell.

17. The measurement apparatus according to claim 15, wherein:
the SERS-substrate is disposed or deposited on the surface of the transmission window adjacent the flow channel inside the cell body;
the optical system includes a prism configured to:
receive excitation light transmitted to the prism along an excitation light path outside the flow channel and to refract the received excitation light through the transmission window of the flow cell towards the SERS-substrate such that an evanescent field extends from the evanescently coupled SERS-substrate into the medium adjacent the SERS-substrate inside the flow channel; and
receive the measurement light including the Raman scattered light emanating from the medium during exposure to the evanescent field through the evanescently coupled SERS-substrate and the transmission window of the flow cell and to provide the measurement light along a measurement light path outside the flow channel,
wherein the prism is either a component of the flow cell adjoining an outside surface of the transmission window opposite the SERS-substrate or a component adjoining an inside surface of a housing window disposed in an opening of a housing wall of a housing of a probe head,
wherein the probe head is configured to be disposed adjacent the flow cell such that an outside surface of the housing window adjoins or faces an outside surface of the transmission window of the flow cell.

18. The measurement apparatus according to claim 15, further comprising a holder; wherein:
the flow cell includes a transparent window or a transparent carrier disposed in an opening extending through the wall section of the cell body opposite the transmission window; and
the holder includes:
two side elements delimiting a receptacle configured to accommodate the flow cell and an opening extending through a first one of the side elements such that the opening exposes the transmission window of the flow cell disposed in the holder; and
a reflector disposed opposite the opening in the first side element and configured to receive light exiting the flow cell disposed in the holder through the transparent window, or the transparent carrier, of the flow cell and to reflect the incident light through the transparent window or the transparent carrier to the SERS-substrate,
wherein the reflector is:
a flat reflector including a flat reflective surface, a curved reflector including a curved reflective surface, a focusing mirror adapted to reflect incident light onto the SERS-substrate or onto a point or a line on the SERS-substrate, or a collimating mirror adapted to reflect the incident light onto an area of the SERS-substrate; and/or
given by an individual component attached to the second side element, by a coating disposed or deposited on the second side element, or by a reflective and/or polished surface of the second side element.
